(19) United States
(12) Patent Application Publication
(10) Pub. No.: US 2012/0113481 A1
(43) Pub. Date: May 10, 2012

(54) IMAGE READING DEVICE AND IMAGE FORMING APPARATUS

(75) Inventor: Masahiko OOTSU, Kanagawa (JP)

(73) Assignee: FUJI XEROX CO., LTD., Tokyo (JP)

(21) Appl. No.: 13/098,990

(22) Filed: May 2, 2011

(30) Foreign Application Priority Data
Nov. 5, 2010 (JP) 2010-249083

(51) Int. Cl. H04N 1/04

(52) U.S. Cl. 358/474

(57) ABSTRACT

An image reading device includes a light guiding unit, a pair of light sources, and a light receiving unit. The light guiding unit has incident surfaces, on which light is incident, at both ends, extends in a main scanning direction, and causes light incident on one of the incident surfaces to be reflected, to propagate toward the other of the incident surfaces, and to be applied from a peripheral surface of the light guiding unit onto a document table. The pair of light sources cause light to be incident on the incident surfaces at both the ends of the light guiding unit. The light receiving unit receives, via an optical system, light emitted from the peripheral surface of the light guiding unit and reflected by a document on the document table.

### CROSS-REFERENCE TO RELATED APPLICATIONS

This application is based on and claims priority under 35 USC 119 from Japanese Patent Application No. 2010-249083 filed Nov. 5, 2010.

### BACKGROUND

(i) Technical Field

The present invention relates to an image reading device and an image forming apparatus.

(ii) Related Art

In recent years, white light-emitting diodes (LEDs) are used for various applications, for example, as a light source of a scanner.

### SUMMARY

According to an aspect of the invention, there is provided an image reading device including: a light guiding unit that has incident surfaces, on which light is incident, at both ends, that extends in a main scanning direction, and that causes light incident on one of the incident surfaces to be reflected, to propagate toward the other of the incident surfaces, and to be applied from a peripheral surface of the light guiding unit onto a document table; a pair of light sources that cause light to be incident on the incident surfaces at both the ends of the light guiding unit; and a light receiving unit that receives, via an optical system, light emitted from the peripheral surface of the light guiding unit and reflected by a document on the document table. The light guiding unit has an optical characteristic in which an amount of light applied from both end portions of the peripheral surface is larger than an amount of light applied from a center portion of the peripheral surface so that a light amount distribution in the main scanning direction is substantially even on a light receiving surface of the light receiving unit.

### BRIEF DESCRIPTION OF THE DRAWINGS

Exemplary embodiments of the present invention will be described in detail based on the following figures, wherein:

FIG. 1 is a diagram illustrating an example configuration of an image reading device according to a first exemplary embodiment of the present invention;

FIG. 2A is a front view illustrating an example of disposing light sources and a light guiding unit, and FIG. 2B is a side view of the light guiding unit;

FIGS. 3A to 3C are diagrams describing optical characteristics of the light guiding unit;

FIG. 4 is a plan view describing a positional relationship between first and second white reference plates;

FIG. 5 is a diagram illustrating a distribution of the amount of light applied from the light guiding unit onto a document;

FIG. 6 is a block diagram illustrating an overview of a control system of the image reading device;

FIG. 7 is a diagram illustrating a circuit to which the light sources are connected;

FIG. 8 is a block diagram illustrating the configuration of a front-surface line sensor and the schematic configuration of a front-surface image read controller;

FIG. 9 is a flowchart illustrating operation of the image reading device according to the first exemplary embodiment;

FIG. 10 is a block diagram illustrating the schematic configuration of a front-surface image read controller according to a second exemplary embodiment of the present invention;

FIG. 11 is a flowchart illustrating operation of an image reading device according to the second exemplary embodiment; and

FIG. 12 is a diagram illustrating an example configuration of an image forming apparatus according to a third exemplary embodiment of the present invention.

### DETAILED DESCRIPTION

Hereinafter, exemplary embodiments of the present invention will be described with reference to the attached drawings. In the drawings, the elements having substantially the same functions are denoted by the same reference numerals, and duplicate description thereof is omitted.

### First Exemplary Embodiment

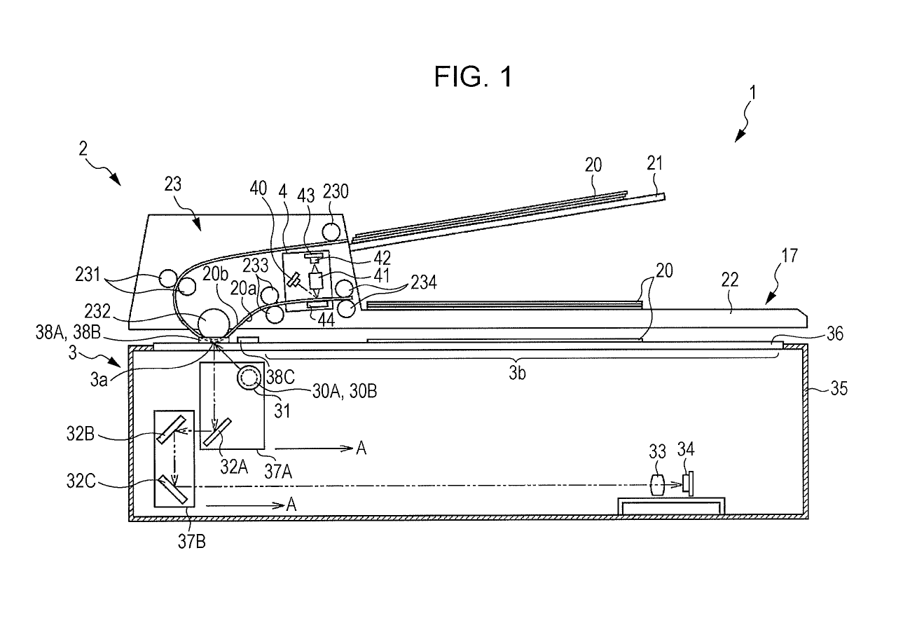

FIG. 1 is a diagram illustrating an example configuration of an image reading device 1 according to a first exemplary embodiment of the present invention.

The image reading device 1 includes a document transport unit 2 that transports a document 20 onto a document table 36 (described below), a front-surface image reader 3 that optically reads an image on a front surface 20a of the document 20, and a rear-surface image reader 4 that is provided in the document transport unit 2 and optically reads an image on a rear surface 20b of the document 20.

The document transport unit 2 and the rear-surface image reader 4 are provided in a document cover 17 that is openable and closable with respect to the document table 36.

The image reading device 1 operates in a first mode, a second mode, or a third mode. In the first mode, carriages 37A and 37B (described below) for holding the optical system of the front-surface image reader 3 are fixed, and the document 20 is transported by the document transport unit 2 through a line-shaped first read area 3a in a sub-scanning direction A to read an image from the front surface 20a of the document 20. In the second mode, the document 20 is placed on the document table 36 so as to be fixed thereon, and the carriages 37A and 37B are moved in the sub-scanning direction A with respect to a rectangular second read area 3b to read an image from the front surface 20a of the document 20. In the third mode, an image is read from the front surface 20a of the document 20 and an image is read from the rear surface 20b of the document 20 while the document 20 is transported by the document transport unit 2 onto the document table 36.

### Document Transport Unit

The document transport unit 2 includes a feeder tray 21 on which the document 20 with images recorded thereon are placed, an output tray 22 to which the transported document 20 is output, and a transport mechanism 23 that transports the document 20 from the feeder tray 21 to the output tray 22.

The transport mechanism 23 includes a separation roller 230 that separates each of plural sheets of the document 20 placed on the feeder tray 21 from a bundle of the sheets, transport rollers 231 that transport the separated sheets of the document 20, a read roller 232 that transports the document 20 to the first read area 3a, guide rollers 233 that guide the document 20 to the rear-surface image reader 4, and output rollers 234 that output the document 20 to the output tray 22.

### Front-Surface Image Reader

The front-surface image reader 3 includes a pair of right and left light sources 30A and 30B that generate illumination light, a light guiding unit 31 that guides the illumination light emitted from the light sources 30A and 30B to the first or second read area 3a or 3b, first to third mirrors 32A to 32C that reflect the illumination light emitted from the light sources 30A and 30B and reflected by the front surface 20a of the document 20 in the first or second read area 3a or 3b, a lens 33 of a reducing optical system for collecting the reflected light led by the first to third mirrors 32A to 32C, and a front-surface line sensor 34, which is an example of a light receiving unit for receiving the light collected by the lens 33.

A charge-coupled device (CCD) line sensor may be used as the front-surface line sensor 34. Alternatively, another type of solid-state imaging device, such as a complementary metal-oxide semiconductor (CMOS) image sensor, may be used.

The front-surface image reader 3 also includes a casing 35 for accommodating the light sources 30A and 30B, the light guiding unit 31, the first to third mirrors 32A to 32C, the lens 33, and the front-surface line sensor 34. The document table 36, which is made of a light transmitting material, such as glass, is provided on the casing 35.

The light sources 30A and 30B, the light guiding unit 31, and the first mirror 32A are fixed to the first carriage 37A, which is movable in the sub-scanning direction A, and the second and third mirrors 32B and 32C are fixed to the second carriage 37B. The second carriage 37B is configured to be movable in the sub-scanning direction A with half the movement amount of the first carriage 37A so that the length of the light path extending from the surface of the document 20 on the document table 36 to the light receiving surface of the front-surface line sensor 34 is kept constant. The first and second carriages 37A and 37B are configured to be moved by a motor (not illustrated) in the sub-scanning direction A to the positions illustrated in FIG. 1 when reading an image on the front surface 20a of the document 20 placed on the document table 36.

First and second white reference plates 38A and 38B are provided at both ends of the first read area 3a on the document table 36, and a third white reference plate 38C is provided near the second read area 3b along a main scanning direction B. The details of the positional relationship among the first to third white reference plates 38A to 38C will be described below.

As the first to third white reference plates 38A to 38C, white resin plates, white-coated metal plates, or the like may be used.

### Rear-Surface Image Reader

The rear-surface image reader 4 includes a light source 40 that generates illumination light, a rod lens array 41 of a 1× magnification optical system for collecting the illumination light emitted from the light source 40 and reflected by the rear surface 20b of the document 20, a rear-surface line sensor 42, which is an example of a light receiving unit that receives the reflected light collected by the rod lens array 41, a substrate 43 on which the rear-surface line sensor 42 is mounted, and a white reference plate 44 that faces the rod lens array 41 via a transport path.

As the light source 40, a fluorescent lamp, a xenon lamp, plural LEDs arranged in the main scanning direction, or the like may be used.

A CCD line sensor may be used as the rear-surface line sensor 42. Alternatively, another type of solid-state imaging device, such as a CMOS image sensor, may be used.

As the white reference plate 44, a white resin plate, a white-coated metal plate, or the like may be used.

### Light Sources and Light Guiding Unit

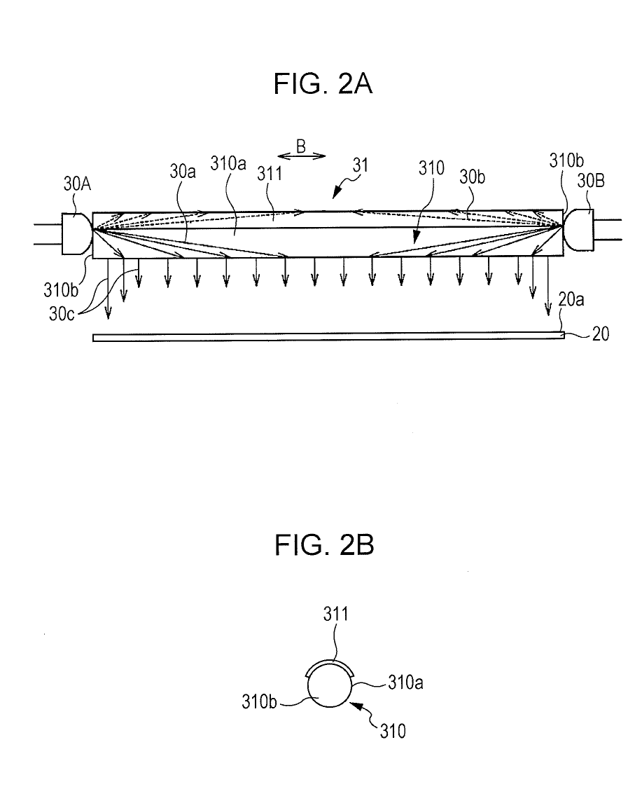

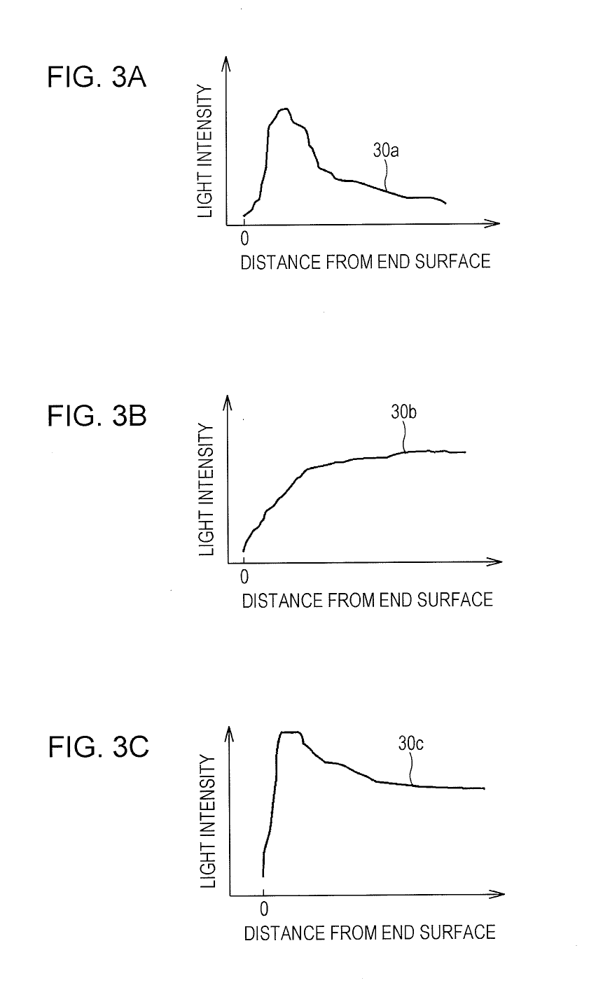

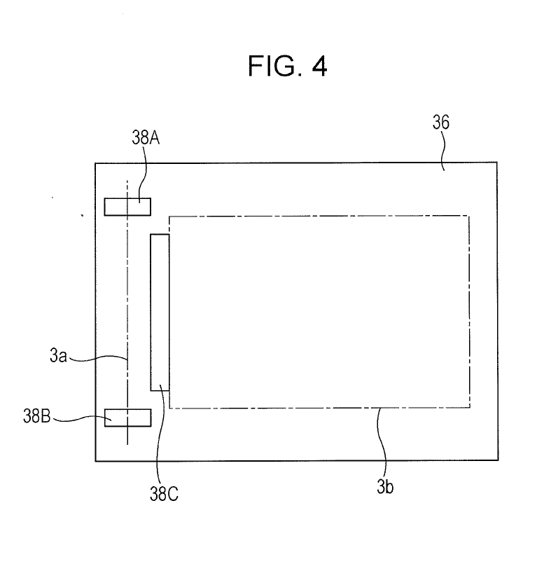

FIG. 2A is a front view illustrating an example of disposing the light sources 30A and 30B and the light guiding unit 31, and FIG. 2B is a side view of the light guiding unit 31. FIGS. 3A to 3C are diagrams describing the optical characteristics of the light guiding unit 31.

Generally, the lens 33 of the reducing optical system of the front-surface image reader 3 has a characteristic of being light with a large amount of light at the center portion thereof in the main scanning direction B, due to the characteristic of the cosine fourth-power law, but being a little dark with a small amount of light at the end portion thereof in the main scanning direction B. In order to improve such a characteristic, the light guiding unit 31 according to this exemplary embodiment has an optical characteristic in which the amount of light applied onto the front surface (document surface) 20a of the document 20 from both the end portions of the peripheral surface is larger than the amount of light applied onto the document surface from the center portion of the peripheral surface so that the light amount distribution in the main scanning direction B is substantially even on the light receiving surface of the front-surface line sensor 34. The light guiding unit 31 having such an optical characteristic may be realized by causing the amount of reflected light at the center portion to be larger than the amount of reflected light at both the end portions in the longitudinal direction (main scanning direction).

As illustrated in FIGS. 2A and 2B, the light guiding unit 31 has a circular cross section, and includes a translucent member 310 formed of quartz or the like, and a reflector 311 formed in an area that is on a peripheral surface 310a of the translucent member 310 and that is on the side opposite to the front surface 20a. The reflector 311 is formed by evaporating metal, such as aluminum. The light sources 30A and 30B are disposed on both end surfaces 310b of the translucent member 310. The reflector 311 may have an identical pattern or different patterns in the main scanning direction. Alternatively, the reflector 311 may be composed of plural reflectors 311, and the size and density of the individual reflectors 311 may be varied to change the light amount distribution in the main scanning direction.

White LED lamps may be used as the light sources 30A and 30B. The white LED lamp is constituted by a blue LED that emits blue light and a lens including a phosphor that converts part of blue light emitted from the blue LED into yellow light. Part of the blue light emitted from the blue LED is converted into yellow light by the phosphor, and the blue light and yellow light are combined together, thereby obtaining white light. The light sources 30A and 30B are not limited to white LEDs, and LEDs that emit light of another color may be used. Alternatively, each of the light sources 30A and 30B may be constituted by plural LEDs. For example, each of the light sources 30A and 30B may be constituted by a red LED that emits red light, a blue LED that emits blue light, and a green LED that emits green light.

Referring to FIG. 2A, the solid lines in the translucent member 310 of the light guiding unit 31 represent light (direct incident light) 30a that is emitted from the LEDs and is applied onto the document 20 without being reflected by a reflection surface. The broken lines in the translucent member 310 of the light guiding unit 31 represent light (indirect incident light) 30b that is emitted from the LEDs and is applied onto the document 20 after being reflected by the reflector 311. The direct incident light 30a illustrated in FIG. 3A and the indirect incident light 30b illustrated in FIG. 3B are combined to form the document surface incident light 30c illustrated in FIG. 3C, and the document surface incident light 30c corresponds to the light applied onto the document 20. As illustrated in FIG. 3C, according to this configuration, the amount of light at the end portion in the main scanning direction may be increased compared to the center portion. Accordingly, the light amount distribution in the main scanning direction is substantially even on the light receiving surface of the front-surface line sensor 34.

### Positions of White Reference Plates

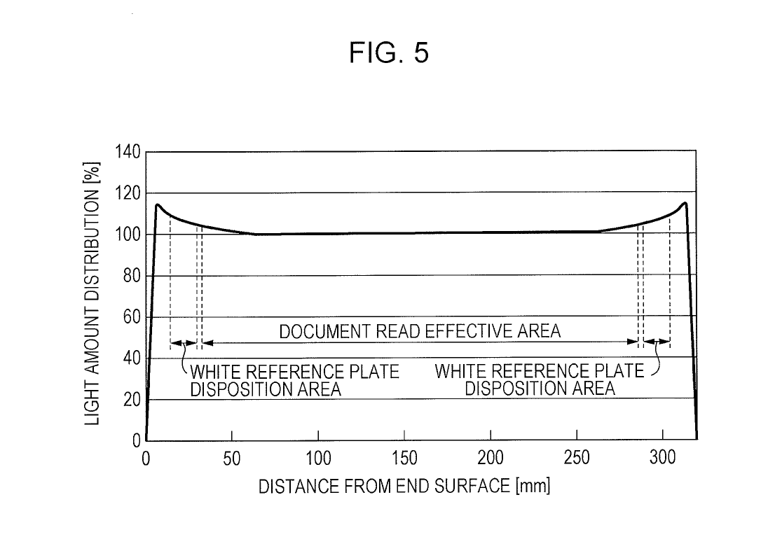

The positions of the first and second white reference plates 38A and 38B will be described with reference to FIGS. 4 and 5. FIG. 4 is a plan view describing the positional relationship between the first and second white reference plates 38A and 38B. FIG. 5 is a diagram illustrating the distribution of the amount of light applied onto the document 20 from the light guiding unit 31.

As illustrated in FIG. 4, the line-shaped first read area 3a for the document 20 transported by the document transport unit 2 is provided along the main scanning direction B on the document table 36. Also, the second read area 3b for the document 20 placed on the document table 36 is provided at the center of the document table 36.

As illustrated in FIG. 4, the first and second white reference plates 38A and 38B are provided at both ends of the first read area 3a. The third white reference plate 38C is provided near the second read area 3b along the main scanning direction B.

As illustrated in FIG. 5, the first and second white reference plates 38A and 38B are disposed so as to be within a white reference plate disposition area outside a document read effective area. The width of the white reference plate disposition area (e.g., 15 mm) is determined so that the fluctuation of the amount of light in the first and second white reference plates 38A and 38B is an allowable value (e.g., 2.5%) or less. In this exemplary embodiment, the width of the first and second white reference plates 38A and 38B is 5 mm, and the first and second white reference plates 38A and 38B are disposed by avoiding the position where the amount of fluctuation of the amount of light per unit length exceeds 0.5%/mm. If the amount of fluctuation of the amount of light per unit length exceeds 0.5%/mm, the sensitivity increases in accordance with the positioning accuracy of the light guiding unit 31 and the light sources 30A and 30B, so that the correction accuracy degrades.

### Control System

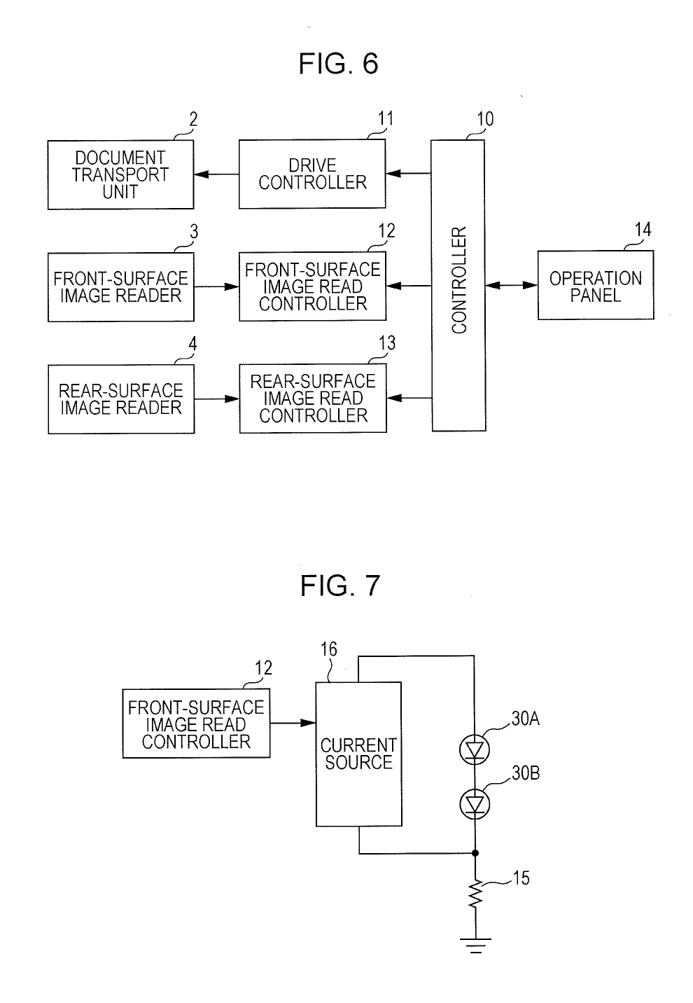

FIG. 6 is a block diagram illustrating the overview of the control system of the image reading device 1. The image reading device 1 includes a controller 10 that controls the entire image reading device 1, a drive controller 11 that controls the document transport unit 2, a front-surface image read controller 12 that controls the reading performed by the front-surface image reader 3, and a rear-surface image read controller 13 that controls the reading performed by the rear-surface image reader 4.

FIG. 7 is a diagram illustrating a circuit to which the light sources 30A and 30B are connected. The white LED lamps forming the light sources 30A and 30B are connected in series and are grounded via a resistor 15. A lighting instruction signal is output from the front-surface image read controller 12 to a current supply 16, whereby the white LED lamps of the light sources 30A and 30B are turned on.

### Front-Surface Image Read Controller

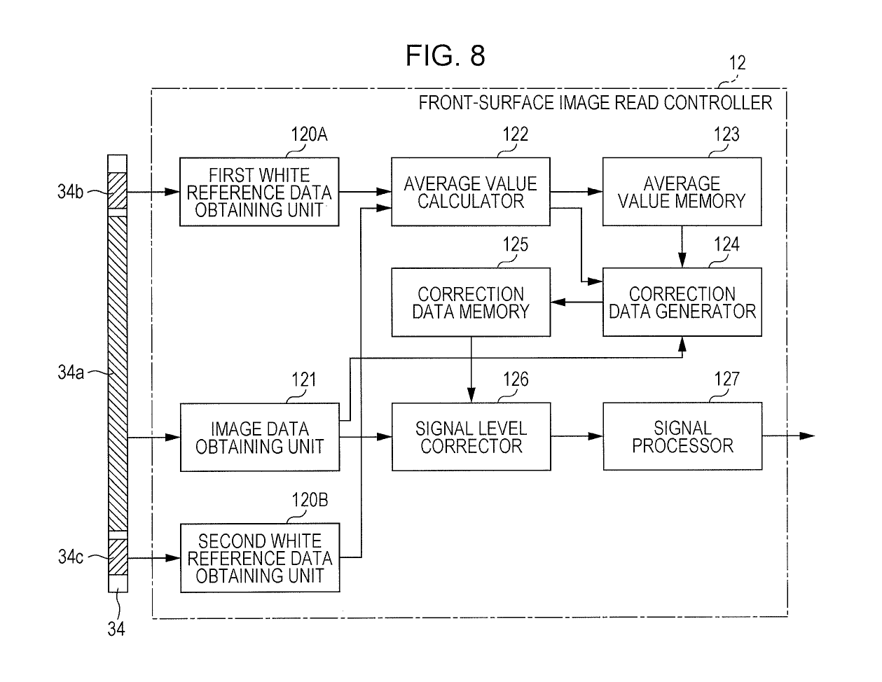

FIG. 8 is a block diagram illustrating the configuration of the front-surface line sensor 34 and the schematic configuration of the front-surface image read controller 12.

### Front-Surface Line Sensor

As illustrated in FIG. 8, the front-surface line sensor 34 includes plural photoelectric conversion elements that are arranged in the main scanning direction. The front-surface line sensor 34 includes a main light receiver 34a constituted by plural photoelectric conversion elements that receive reflected light from the front surface 20a of the document 20, a first sub-light receiver 34b constituted by plural photoelectric conversion elements that receive reflected light from the first white reference plate 38A, and a second sub-light receiver 34c constituted by plural photoelectric conversion elements that receive reflected light from the second white reference plate 38B.

### Front-Surface Image Read Controller

As illustrated in FIG. 8, the front-surface image read controller 12 includes first and second white reference data obtaining units 120A and 120B, an image data obtaining unit 121, an average value calculator 122, an average value memory 123, a correction data generator 124, a correction data memory 125, a signal level corrector 126, and a signal processor 127.

The first white reference data obtaining unit 120A performs A/D conversion on the signals output from the respective photoelectric conversion elements of the first sub-light receiver 34b of the front-surface line sensor 34, averages the signals, and obtains an average as first white reference data.

The second white reference data obtaining unit 120B performs A/D conversion on the signals output from the respective photoelectric conversion elements of the second sub-light receiver 34c of the front-surface line sensor 34, averages the signals, and obtains an average as second white reference data.

The image data obtaining unit 121 performs A/D conversion on the signals output from the respective photoelectric conversion elements of the main light receiver 34a of the front-surface line sensor 34, and obtains the signals as image data.

The average value calculator 122 calculates an average value by averaging the first white reference data and the second white reference data obtained by the first and second white reference data obtaining units 120A and 120B, respectively, and stores the average value in the average value memory 123.

The correction data generator 124 generates shading correction data for correcting shading on the basis of the data output from the front-surface line sensor 34 when the data is read from the third white reference plate 38C, and stores the shading correction data in the correction data memory 125. Also, the correction data generator 124 generates read correction data for correcting variations of a read characteristic in the main scanning direction B on the basis of the previous average value stored in the average value memory 123 and the current average value calculated by the average value calculator 122 this time, and stores the read correction data in the correction data memory 125. Specifically, the correction data generator 124 calculates the ratio between the previous average value D₃′ and the current average value D₃ (D₃′/D₃), and regards the ratio as the read correction data. Alternatively, the correction data generator 124 may calculate D₃′−D₃ as other read correction data and add the read correction data (D₃′−D₃) to the signal level of image data.

The signal level corrector 126 performs signal processing for correcting the signal level of the image data output from the image data obtaining unit 121 on the basis of the shading correction data and light amount correction data stored in the correction data memory 125. Specifically, the signal level corrector 126 performs correction by multiplying the signal level of the image data output from the image data obtaining unit 121 by the shading correction data and the read correction data (ratio D₃′/D₃).

The signal processor 127 processes the image data on which signal level correction has been performed by the signal level corrector 126, and outputs the processed image data as an image signal.

The average value memory 123 and the correction data memory 125 are constituted by a read only memory (ROM), a random access memory (RAM), or the like.

### Operation According to First Exemplary Embodiment

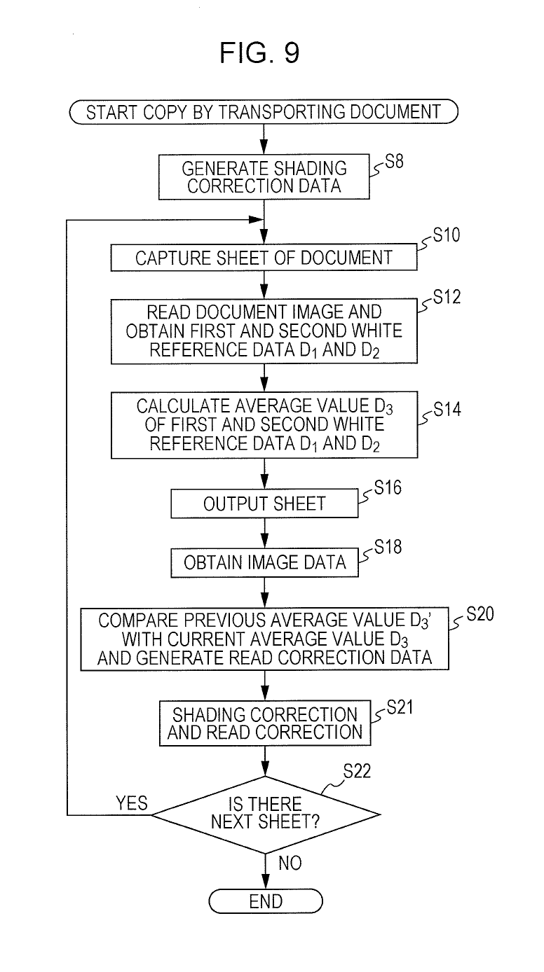

Next, the operation according to the first exemplary embodiment will be described with reference to the flowchart in FIG. 9.

A user places a bundle of plural sheets of the document 20 on the feeder tray 21, operates an operation panel 14 to select the first mode, for example, and presses a start button (not illustrated) provided on the operation panel 14. Then, the front-surface image read controller 12 controls a motor (not illustrated) to move the first and second carriages 37A and 37B to the positions for reading the third white reference plate 38C, under the control performed by the controller 10. The front-surface image read controller 12 controls the front-surface image reader 3 to read the third white reference plate 38C. The image data obtaining unit 121 performs A/D conversion on the signals output from the respective photoelectric conversion elements of the main light receiver 34a of the front-surface line sensor 34, and obtains the signals as white reference data. The correction data generator 124 generates shading correction data from the white reference data obtained by the image data obtaining unit 121, and stores the shading correction data in the correction data memory 125 (S8).

Subsequently, the front-surface image read controller 12 controls the motor (not illustrated) to move the first and second carriages 37A and 37B to the positions illustrated in FIG. 1, that is, to the positions for reading the first read area 3a. The drive controller 11 controls the document transport unit 2 to capture the sheets of the document 20 placed on the feeder tray 21 one by one (S10).

When the first sheet of the document 20 passes the first read area 3a, the front surface 20a of the first sheet of the document 20 is read. At the same time, the individual photoelectric conversion elements of the first sub-light receiver 34b of the front-surface line sensor 34 output signals in accordance with the amount of light reflected by the first white reference plate 38A. The first white reference data obtaining unit 120A performs A/D conversion on the signals output from the respective photoelectric conversion elements of the first sub-light receiver 34b, averages the signals, and obtains an average as first white reference data D₁.

The individual photoelectric conversion elements of the second sub-light receiver 34c output signals in accordance with the amount of light reflected by the second white reference plate 38B. The second white reference data obtaining unit 120B performs A/D conversion on the signals output from the respective photoelectric conversion elements of the second sub-light receiver 34c, averages the signals, and obtains an average as second white reference data D₂ (S12).

The average value calculator 122 calculates an average value D₃ of the first white reference data D₁ and the second white reference data D₂ obtained by the first and second white reference data obtaining units 120A and 120B, respectively, and stores the average value D₃ in the average value memory 123 (S14).

The sheet of the document 20 in which the image on the front surface 20a has been read is output to the output tray 22 under the control performed by the drive controller 11 (S16).

The individual photoelectric conversion elements of the main light receiver 34a of the front-surface line sensor 34 output signals in accordance with the amount of light reflected by the front surface 20a of the first sheet of the document 20. The image data obtaining unit 121 performs A/D conversion on the signals output from the respective photoelectric conversion elements of the main light receiver 34a, and obtains the signals as image data (S18).

The correction data generator 124 regards the average value D₃ stored in the average value memory 123 as the previous average value D₃′, calculates the ratio (D₃′/D₃) between the previous average value D₃′ and the current average value D₃ calculated by the average value calculator 122 this time, and stores the ratio (D₃′/D₃) as read correction data in the correction data memory 125 (S20).

The signal level corrector 126 multiplies the signal level of the image data output from the image data obtaining unit 121 by the shading correction data and the read correction data (ratio D₃′/D₃) stored in the correction data memory 125, and outputs the product to the signal processor 127 (S21).

The signal processor 127 processes the image data on which signal level correction has been performed by the signal level corrector 126, and outputs the processed image data as an image signal.

The drive controller 11 determines whether or not the next sheet of the document 20 exists on the feeder tray 21 (S22). If the next sheet of the document 20 exists on the feeder tray 21 (YES in S22), the foregoing process is performed on the next sheet of the document 20 until it is determined that there exists no more sheet of the document 20 on the feeder tray 21 (NO in S22). That is, the process including capturing a sheet (S10), obtaining white reference data D₁ and white reference data D₂ (S12), calculating an average value D₃ (S14), outputting the sheet (S16), obtaining image data (S18), generating read correction data (S20), and shading correction and read correction (S21) is performed.

### Second Exemplary Embodiment

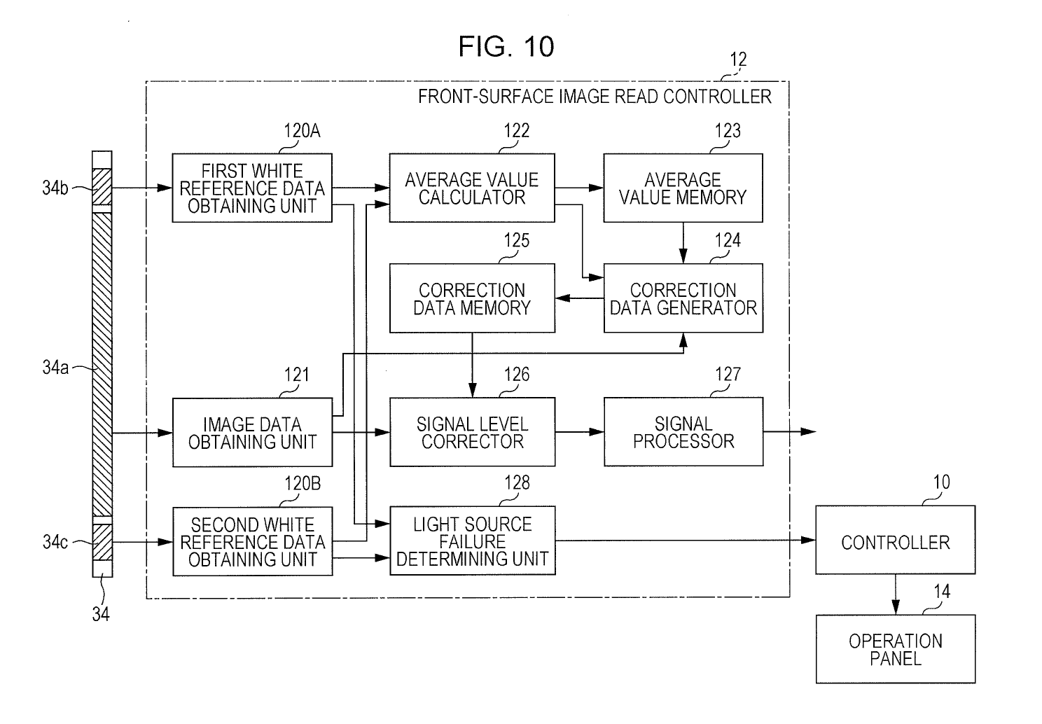

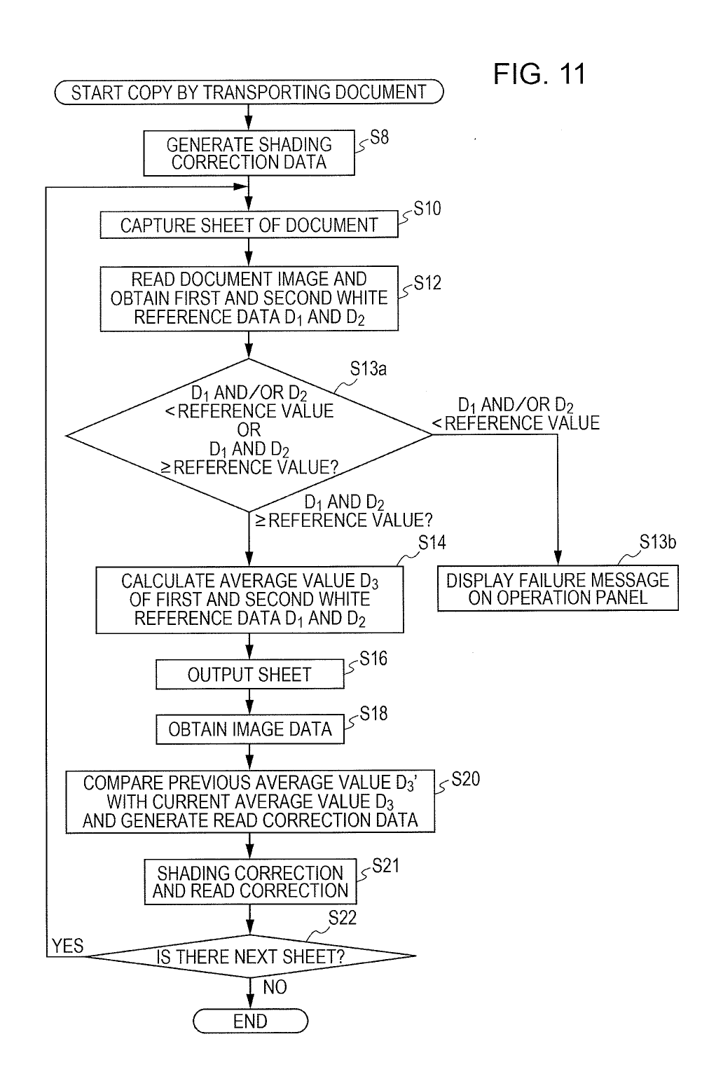

FIG. 10 is a block diagram illustrating the schematic configuration of a front-surface image read controller 12 according to a second exemplary embodiment of the present invention.

The front-surface image read controller 12 according to the second exemplary embodiment is configured similarly to the front-surface image read controller 12 according to the first exemplary embodiment, except that a light source failure determining unit 128 is provided in the preceding stage of the average value calculator 122.

The light source failure determining unit 128 determines whether or not the light sources 30A and 30B have a failure on the basis of the first white reference data obtained by the first white reference data obtaining unit 120A and the second white reference data obtained by the second white reference data obtaining unit 120B. Specifically, when one of the light sources 30A and 30B has a failure, the white reference data of the light source having the failure has a small value. By using this principle, when the first or second white reference data has a value smaller than a reference value, the light source failure determining unit 128 determines that the light source corresponding to the small value in the light sources 30A and 30B has a failure, and notifies the controller 10 of the fact. The controller 10 receives the notification indicating that one of the light sources 30A and 30B has a failure from the light source failure determining unit 128, and then displays information representing the fact on the touch panel of the operation panel 14. When both the light sources 30A and 30B have a failure, both the white reference data D₁ and white reference data D₂ have a value smaller than the reference value, and thus the light source failure determining unit 128 notifies the controller 10 that both the light sources 30A and 30B have a failure. Accordingly, the controller 10 displays information representing that both the light sources 30A and 30B have a failure on the touch panel of the operation panel 14.

### Operation According to Second Exemplary Embodiment

Next, the operation according to the second exemplary embodiment will be described with reference to the flowchart in FIG. 11.

As in the first exemplary embodiment, shading correction data is generated (S8), a sheet of document is captured (S10), and white reference data D₁ and white reference data D₂ are obtained (S12). Then, the light source failure determining unit 128 compares each of the white reference data D₁ and white reference data D₂ with the reference value (S13a). If the white reference data D₁ and/or the white reference data D₂ have/has a value smaller than the reference value, the light source failure determining unit 128 determines that the light source 30A and/or the light source 30B corresponding to the small value have/has a failure, and displays information representing the fact on the touch panel of the operation panel 14 (S13b).

If both the white reference data D₁ and the white reference data D₂ have a value equal to or larger than the reference value, an average value D₃ is calculated (S14), the sheet is output (S16), image data is obtained (S18), read correction data is generated (S20), and shading correction and read correction are performed (S21) as in the first exemplary embodiment. These operations are repeated until there is no more sheet of the document 20 on the feeder tray 21.

### Third Exemplary Embodiment

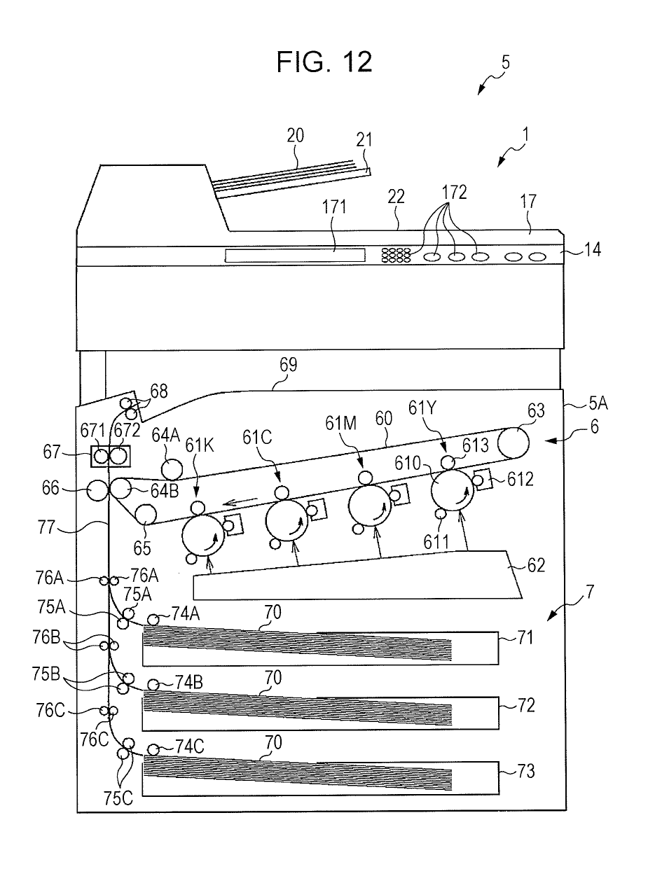

FIG. 12 is a diagram illustrating an example configuration of an image forming apparatus 5 according to a third exemplary embodiment of the present invention. The image forming apparatus 5 includes the image reading device 1 according to the first or second exemplary embodiment and a body unit 5A.

The body unit 5A includes an image forming section 6 that prints a document image read by the image reading device 1 on paper 70, which is a recording medium, and a tray section 7 that supplies the paper 70 to the image forming section 6.

A document cover 17 is provided with a touch panel 171 and operation buttons 172. The operation buttons 172 include a start button used for providing an instruction to read a document or print an image, a stop button used for providing an instruction to stop printing an image, and so forth.

The image forming section 6 prints a document image on paper using an electrophotographic system, and includes an intermediate transfer belt 60, first to fourth image forming units 61Y, 61M, 61C, and 61K, and an optical scanning device 62. The intermediate transfer belt 60 circulates and has no end. The first to fourth image forming units 61Y, 61M, 61C, and 61K transfer toner images of respective colors: yellow (Y); magenta (M); cyan (C); and black (K), onto the intermediate transfer belt 60. The optical scanning device 62 serves as an exposure unit that causes photoconductor drums 610 (described below) of the first to fourth image forming units 61Y, 61M, 61C, and 61K to be exposed to laser light that is modulated on the basis of image information, thereby forming electrostatic latent images on the photoconductor drums 610.

Each of the image forming units 61Y, 61M, 61C, and 61K includes a photoconductor drum 610, a charging device 611 that evenly charges the surface of the photoconductor drum 610, a developing device 612 serving as a developing unit that develops the electrostatic latent image formed on the surface of the photoconductor drum 610 by the optical scanning device 62 using toner of the corresponding color, thereby forming a toner image, and a first transfer roller 613 that presses the intermediate transfer belt 60 to the photoconductor drum 610.

The intermediate transfer belt 60 is driven by a drive roller 63 connected to a motor (not illustrated), and is rotated along a circulation path that is formed by a first driven roller 64A, a second driven roller 64B, and a tension roller 65 that gives tension to the intermediate transfer belt 60.

Also, the image forming section 6 includes a second transfer roller 66, a fixing unit 67, and output rollers 68. The second transfer roller 66 is disposed so as to face the second driven roller 64B with the intermediate transfer belt 60 therebetween, and serves as a transfer unit that transfers a toner image formed on the intermediate transfer belt 60 onto paper supplied from the tray section 7. The fixing unit 67 serves as a fixing unit that fixes a toner image transferred onto paper to the paper. The output rollers 68 output the paper 70 that has passed through the fixing unit 67 to an output tray 69.

The fixing unit 67 includes a fixing roller 671 having a heater therein, and a pressure roller 672 that applies pressure to the fixing roller 671.

The tray section 7 includes first to third trays 71 to 73 that accommodate the paper 70 of different orientations, sizes, and qualities. The tray section 7 also includes pickup rollers 74A to 74C for picking up the paper 70 from the corresponding first to third trays 71 to 73, separation rollers 75A to 75C for separating plural sheets of the paper 70 from one another when the sheets are picked up, and registration rollers 76A to 76C for transporting the paper 70 to a downstream side. The registration rollers 76A to 76C are configured to operate in synchronization with the timing of image formation performed by the image forming section 6 and guide the paper 70 picked up from the first to third trays 71 to 73 to the position between the second transfer roller 66 and the intermediate transfer belt 60 along a transport path 77.

The present invention is not limited to the above-described exemplary embodiments, and various modifications are acceptable without changing the gist of the present invention. For example, the light guiding unit is a translucent member extending in the main scanning direction, and the translucent member may have a characteristic in which the light transmittance at a center portion in the main scanning direction is lower than the light transmittance at both ends in the main scanning direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device comprising:
a light guiding unit that has incident surfaces, on which light is incident, at both ends, that extends in a main scanning direction, and that causes light incident on one of the incident surfaces to be reflected, to propagate toward the other of the incident surfaces, and to be applied from a peripheral surface of the light guiding unit onto a document table;
a pair of light sources that cause light to be incident on the incident surfaces at both the ends of the light guiding unit; and
a light receiving unit that receives, via an optical system, light emitted from the peripheral surface of the light guiding unit and reflected by a document on the document table,
wherein the light guiding unit has an optical characteristic in which an amount of light applied from both end portions of the peripheral surface is larger than an amount of light applied from a center portion of the peripheral surface so that a light amount distribution in the main scanning direction is substantially even on a light receiving surface of the light receiving unit.

2. The image reading device according to claim 1, wherein the light guiding unit includes a translucent member extending in the main scanning direction and a reflector formed in an area that is on a peripheral surface of the translucent member and that is opposite to the document table.

3. The image reading device according to claim 2, wherein the reflector has different patterns in the main scanning direction.

4. The image reading device according to claim 1, wherein the light guiding unit is a translucent member extending in the main scanning direction, and a light transmittance at a center portion of the translucent member in the main scanning direction is lower than a light transmittance at both end portions of the translucent member in the main scanning direction.

5. The image reading device according to claim 1, further comprising:
a pair of white reference plates that are disposed on both sides of an effective read area for the document;
first and second obtaining units that obtain, from the light receiving unit, light amount data concerning light emitted from the light guiding unit and reflected by the pair of white reference plates; and
a generating unit that generates correction data on the basis of the light amount data obtained by the first and second obtaining units.

6. The image reading device according to claim 5, further comprising:
a light source failure determining unit that determines whether at least one of the pair of light sources has a failure on the basis of the light amount data obtained by the first and second obtaining units.

7. An image forming apparatus comprising:
the image reading device according to claim 1 that reads an image from a document;
an exposure unit that causes a photoconductor to be exposed to light on the basis of the image read by the image reading device, so as to form an electrostatic latent image on the photoconductor;
a developing unit that develops the electrostatic latent image formed on the photoconductor to form a toner image;
a transfer unit that transfers the toner image onto paper; and
a fixing unit that fixes the toner image transferred onto the paper.

8. An image reading device for irradiating a document placed on a document placing table with light, comprising:
a longitudinal light guiding unit that has light input surfaces at both ends, end portions, a center portion, and a light irradiation periphery, the longitudinal light guiding unit extending in a main scanning direction;
a pair of light sources positioned at the both ends of the longitudinal light guiding unit; and
a light receiving unit that receives light emitted from the light irradiation periphery and reflected from the document,
wherein the longitudinal light guiding unit has an optical characteristic in which an amount of light emitted from one of the end portions is larger than an amount of light emitted from the center portion.
